(19) United States
(12) Patent Application Publication
(10) Pub. No.: US 2004/0044517 A1
(43) Pub. Date: Mar. 4, 2004

(54) Translation system

(76) Inventor: Robert Palmquist, Faribault, MN (US)

Correspondence Address: SHUMAKER & SIEFFERT, P. A., 8425 SEASONS PARKWAY, SUITE 105, ST. PAUL, MN, 55125, US

(21) Appl. No.: 10/234,015

(22) Filed: Aug. 30, 2002

(51) Int. Cl. G06F 17/28

(52) U.S. Cl. 704/7

(57) ABSTRACT

The invention provides techniques for translation of messages in one language to another. A translation system may receive the messages in spoken form. A message may be transmitted to a server, which translates the message, and may generate the translation in audio form. When the server identifies an ambiguity in the course of translation, the server may interrogate a party to the conversation about an identified ambiguity. By receiving a response to the interrogation, the server may generate a translation that more accurately conveys the meaning that the party wished to convey. A user may customize the translation system in a number of ways, including by specification of a dictionary sequence.

### TECHNICAL FIELD

The invention relates to electronic communication, and more particularly, to electronic communication with language translation.

### BACKGROUND

The need for real-time language translation has become increasingly important. As international interaction becomes more common, people are more likely to encounter a language barrier. In particular, many people may experience the language barrier during verbal communication via electronic means, such as by telephone. The language barrier may arise in many situations, such as trade or negotiations with a foreign company, cooperation of forces in a multi-national military operation in a foreign land, or conversation with foreign nationals regarding everyday matters.

There are computer programs that can transcribe spoken language into written language and vice versa, and computer programs that can translate from one language to another. These programs are, however, prone to error. In particular, the programs are prone to a failure to convey the intended meaning. The failure may be due to several causes, such as the inability to recognize homophones, words having multiple meanings, or the use of jargon.

### SUMMARY

In general, the invention provides techniques for translation of messages from one language to another. In an electronic voice communication such as communication by telephone, a message is typically received in the form of a string of spoken words. The message is received by a translation system and is transmitted as an audio stream to a translation server. The server may include resources to recognize the words, phrases or clauses in the audio stream, to translate the words, phrases or clauses to a second language, and to generate the translated message in audio form.

Two parties to a conversation may use the invention to speak to one another, with the server acting as interpreter. In the course of translating messages, however, the server may encounter aspects of the message that are difficult to translate. For example, the server may identify one or more ambiguities in a message. The invention provides techniques whereby the server may interrogate a party to the conversation about an aspect such as an identified ambiguity to learn the meaning that the a party wished to convey. The response to the interrogation may be used in making a more accurate translation. The server may offer degrees of interrogation that may make translations more accurate. In addition, the server may store the identified ambiguity and the response to interrogation in memory, and may refer to memory if the ambiguity should be identified at a later time.

The translation system may be customized. A user of the system may, for example, select the languages in which the messages will be received. In some cases, the server may include a choice of translation engines and other translation resources, and the user may be able to select the resources to be used. The user may also specify a “dictionary sequence,” e.g., a hierarchy of lexicons that may improve the efficiency of the translation.

The invention may be implemented as a translation services management system, in which the server may translate messages in a variety of languages to other languages. One or more database servers may store a collection of translation resources, such as translation engine files. Translation engine files may include data such as vocabulary and grammar rules, as well as procedures and tools for performing translation. Database servers may also store resources such as drivers for voice recognizers or speech synthesizers, or an assortment of specialized lexicons that a user may include in a dictionary sequence.

In one embodiment, the invention presents a method comprising receiving a message in a first language from a user and translating the message to a second language. The method further includes interrogating the user about an aspect of the message and translating the message to a second language based at least in part on the interrogation. The user may be interrogated about an identified ambiguity in at least one of the received message and the translated message. Upon receiving a response from the user to the interrogation, the method may also include using the response to translate the message to a second language.

In another embodiment, the invention is directed to a system comprising a translation engine that translates a message in the first language to a second language. The system further includes a controller that interrogates a user when the translation engine identifies an ambiguity when translating the message in the first language to a second language. The system may also include a voice recognizer, a voice identifier and a speech synthesizer for processing a spoken conversation.

In a further embodiment, the invention is directed to a method comprising receiving audio messages in different languages, translating the messages to the counterpart languages, and storing a transcript that includes the messages.

In an additional embodiment, the invention is directed to a method comprising receiving a first language and a second language specified by a user, and selecting a translation engine file as a function of one or both languages. The method may also include interrogating the user and selecting a translation engine file as a function of the response of the user to the interrogation.

In another embodiment, the invention presents a system comprising a database storing a plurality of translation engine files and a controller that selects a translation engine file from the plurality of translation engine files. The system may receive languages specified by a user and select the translation engine file as a function of the specified languages. In addition to translation engine files, the database may store other translation resources.

In an added embodiment, the invention is directed to a method comprising translating a first portion of a first message in a first language to a second language, identifying an ambiguity in the first message, interrogating a user about the ambiguity, receiving a response to the interrogation, translating a second portion of the first message to the second language as a function of the response, and translating a second message in the first language to a second language as a function of the response. The method may further include identifying a second ambiguity in the second message and searching a memory for previous identifications of the second ambiguity.

In a further embodiment, the invention is directed to a method comprising receiving a dictionary sequence from a user. The method may also include parsing a received message in the first language into subsets, such as words, phrases and clauses, and searching the dictionaries in the sequence for the subsets.

In a further embodiment, the invention is directed to a method of pause-triggered translation. The method includes receiving an audio message in a first language, recognizing the audio message, storing the recognized audio message in memory and detecting a pause in the audio message. Upon detection of the pause, the method provides for translating the recognized audio message to a second language.

The invention may offer several advantages. In some embodiments, the translation system can provide translation services for several conversations, in which several languages may be spoken. The system may offer a range of translation services. In some embodiments, the system and the user may cooperate to craft an accurately translated message. The system may further allow a user to customize the system to the user's particular needs by, for example, controlling a degree of interrogation or selecting a dictionary sequence.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of a translation system.

FIG. 2 is a block diagram of the translation system of FIG. 1 in further detail.

FIG. 3 is a dictionary hierarchy illustrating an exemplary dictionary sequence.

FIG. 4 is an example of an interrogation screen.

FIG. 5 is a flow diagram that provides an example of operations of the server side of the translation system.

FIG. 6 is a flow diagram that provides an example of selection of translation resources by the server side of the translation system.

FIG. 7 is a block diagram of a network-based translation services management system.

### DETAILED DESCRIPTION

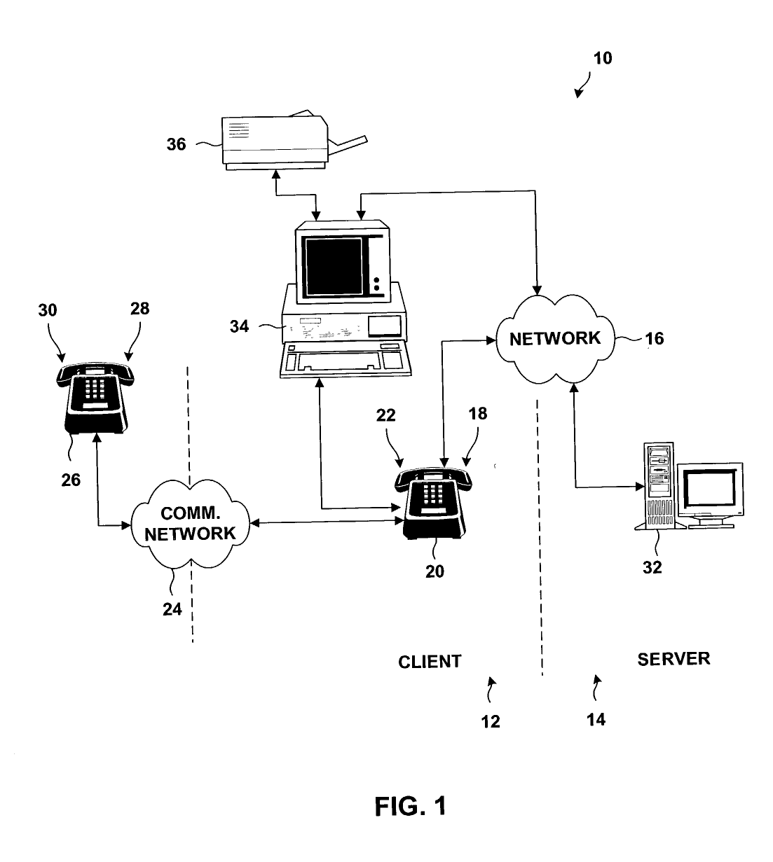

FIG. 1 is a diagram illustrating a translation system 10 that may be used by parties to a conversation. Translation system 10 comprises a client side 12 and server side 14, separated from each other by a network 16. Network 16 may be any of several networks, such as the Internet, a cellular telephone network, a local area network or a wireless network. System 10 receives input in the form of a message, the message being composed in a language. In the embodiments described below, the message will be described as being received as a message spoken in a first language, but the invention is not limited to messages that are spoken. Translation system 10 may receive the spoken message via a sound-detecting transducer.

Translation system 10 translates the message from the first language to a second language. The message in the second language may be transmitted to one or more of the parties to the conversation. Translation system 10 may generate the message in the second language in the form of spoken language via a sound-generating transducer. In one application of the invention, therefore, parties to the conversation may speak to one another in their respective languages, with translation system 10 performing the translation and relaying the translated messages as audio streams.

In FIG. 1, a sound-detecting transducer is embodied in a microphone 18 in telephone 20, and a sound-generating transducer is embodied in speaker 22 of telephone 20. Telephone 20 is coupled to client side 12 of network 16. Telephone 20 may also be coupled via communication network 24, such as the public switched telephone network (PSTN), to another telephone 26, which may include a sound-detecting transducer 28 such as a microphone and a sound-generating transducer 30 such as a speaker. The spoken message may also be received via microphone 18 or microphone 28, or both. Communication network 24 may be any communication network that conveys spoken messages.

In a typical application of the invention, a first party speaking a first language uses telephone 20 and second party speaking a second language uses telephone 26. The invention is not limited to telephones but may use any sound-detecting and sound-generating transducers, such as speakerphones. In addition, system 10 may include any number of telephones or transducers.

A translation server 32 may facilitate communication between the parties in their respective languages. In particular, server 32 may recognize the message in a first language and translate the recognized message into a second language. The second language may be a written or spoken language, or a combination of both. In an exemplary embodiment of the invention, server 32 uses written and spoken language to improve the accuracy of the interpretation between languages. In particular, server 32 may aid one or more of the parties in conveying an intended meaning of a message, such as by interrogating a party via a local workstation 34. Interrogation will be described in more detail below. In addition, workstation 34 or server 32 may record the conversation and may print a transcript of the conversation with printer 36.

Telephone 20 may be coupled to network 16 directly, or telephone 20 may be coupled indirectly to network 16 via workstation 34. In some embodiments of the invention, telephones 20 and 26 may be coupled directly or indirectly to network 16. In other words, network 16 may serve the same function as communication network 24, providing not only the communication path to server 32, but also providing the communication path for the parties to converse with each other.

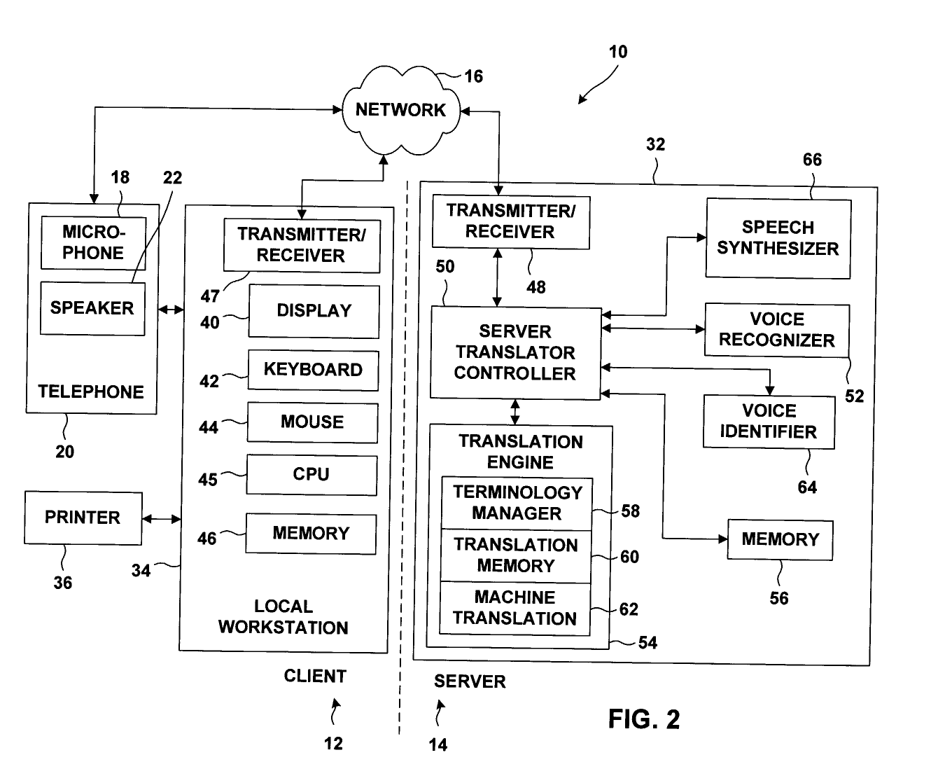

FIG. 2 is a functional block diagram of system 10. Some of the components of FIG. 2 are depicted as logically separate even though the components may be realized in a single device. In the description that follows, a first party, or “user” of system 10, interacts with client side 12. The user interacts, for example, with a sound-detecting transducer and a sound-generating transducer, exemplified by speaker 22 and microphone 18 of telephone 20. The user interacts with the sound-detecting transducer and the sound-generating transducer in a normal way, i.e., by speaking and listening. Telephone 20 may share a communicative link with another device such as telephone 26 (not shown in FIG. 2) via a communication network 24 (not shown in FIG. 2).

The user may also interact with system 10 through local workstation 34. Local workstation 34 may be embodied as a desktop device, such as a personal computer, or a handheld device, such as a personal digital assistant (PDA). In some embodiments, local workstation 34 and telephone 20 may be embodied in a single device, such as a cellular telephone.

The user may also interact with local workstation 34 using any of a number of input/output devices. Input/output devices may include a display 40, a keyboard 42 or a mouse 44. The invention is not limited to the particular input/output devices shown in FIG. 2, however, but may include input/output devices such as a touchscreen, a stylus, a touch pad, or audio input/output devices.

Local workstation 34 may include a central processing unit (CPU) 45. CPU 45 may execute software such as browsers in local memory 46 or software downloaded from translation server 32. Downloaded software and other data may be stored in local memory 46. Workstation 34 may establish a connection with network 16 and server 32 via transmitter/receiver 47.

On server side 14, server 32 may interface with network 16 via transmitter/receiver 48. Transmitter/receiver 48 may be, for example, a Telephony Application Programmers Interface (TAPI) or other interface that can send and receive audio streams of voice data. Server 32 may receive data in several forms. First, server 32 may receive commands or other data entered into workstation 34 by the user. Second, server 32 may receive voice data in the form of an audio stream of words spoken in a first language from the user, collected via microphone 18. Third, server 32 may receive voice data in the form of an audio stream of words spoken a second language from a party in voice communication with the user. Words spoken in the second language may be sensed via a sound-detecting transducer such as microphone 28 in telephone 26. Server 32 may receive other forms of data as well. In some embodiments of the invention, server 32 may receive voice commands.

A server translator controller 50 may be responsive to the commands of the user, and handle and process messages in different languages. Controller 50 may be embodied as one or more programmable processors that oversee the translation, regulate communication with the user, and govern the flow of information.

In response to receipt of a message, server 32 may translate the message from one language to another. The message may be supplied to server 32 by the user speaking in a first language, i.e., a language with which the user is familiar. Server 32 may translate the message in the first language to a second language, with which the user is unfamiliar but with which the other party to the conversation is familiar. Server 32 may generate the translated message in a written or audio form of the second language. Similarly, server 32 may receive a spoken message in the second language, may translate the message to the first language, and may generate the translation in written or audio form. In this way, server 32 facilitates communication between parties speaking two languages.

In the case of a message generated by the user in the first language, the user enters the message via microphone 18. The user enters the message by speaking in the first language. The message may be transmitted as an audio stream of voice data via network 16 to server 32. Translator controller 50 may pass the audio stream to a voice recognizer 52. Voice recognizers are commercially available from different companies. Voice recognizer 52 may convert the voice data into a translatable form. In particular, voice recognizer 52 may parse the voice data into subset messages, e.g., words, phrases and/or clauses, which may be transmitted to and a translation engine 54 for translation to the second language. In addition, voice recognizer 52 may convert the voice data to a transcript, which may be stored in a translation buffer in memory 56. The translation generated by translation engine 54 likewise may be stored in memory 56.

Memory 56 may include any form of information storage. Memory 56 is not limited to random access memory, but may also include any of a variety computer-readable media comprising instructions for causing a programmable processor, such as controller 50, to carry out the techniques described herein. Such computer-readable media include, but are not limited to, magnetic and optical storage media, and read-only memory such as erasable programmable read-only memory or flash memory accessible by controller 50.

Translation engine 54 may be embodied as hardware, software, or a combination of hardware and software. Translation engine 54 may employ one or more specialized translation tools to convert a message from one language to another. Specialized translation tools may include terminology manager 58, translation memory tools 60 and/or machine translation tools 62.

Terminology manager 58 generally handles application-specific terminology. Translation engine 54 may employ more than one terminology manager. Examples of terminology managers will be given below. Translation memory tools 60 generally reduce translation effort by identifying previously translated words and phrases, which need not be translated “from scratch.” Machine translation tools 62 linguistically process a message in a language “from scratch” by, for example, parsing the message and analyzing the words or phrases. Terminology manager 58, translation memory tools 60 and/or machine translation tools 62 are commercially available from several different companies. As will be described below, the tools used by translation engine 54 may depend upon the first language, the second language, or both.

Optionally, server 32 may include a voice identifier 64. Voice identifier 64 may identify the person speaking. In the event there are several users using a speakerphone, for instance, voice identifier 64 may be able to distinguish the voice of one person from the voice of another. When server 32 is configured to accept voice commands, voice identifier 64 may be employed to recognize users authorized to give voice commands.

Translation engine 54 may generate a translation in the second language. The translation may be transmitted over network 16 in a written form or in voice form, and thereafter relayed to the second party to the conversation. In a typical application, the translation will be supplied to a speech synthesizer 66. Speech synthesizer 66 generates voice data in the second language as a function of the translation. Translators and speech synthesizers are likewise commercially available from different companies.

The voice data in the second language may be transmitted via network 16 to the user. Voice data in the second language may be relayed via communication network 24 (see FIG. 1) to the second party to the conversation, who hears the translation via speaker 30.

In the case of voice data generated by the second party in the second language, a translation may be obtained with similar techniques. Words spoken in the second language by the second party may be detected by microphone 28 and transferred via communication network 24 to client side 12. Voice data in the second language may be transmitted via network 16 to server 32. Translator controller 50 may pass the voice data to voice recognizer 52, which may convert the voice data into a translatable form that may be translated by translation engine 54 into the first language. The translation in the first language may be transmitted over network 16 in a written form or in voice form generated by speech synthesizer 66. In this way, two parties may carry on a voice-to-voice conversation. Server 32 may automatically serve as translator for both sides of the conversation.

In addition, controller 50 may automatically save a transcript of the conversation. The user may download the transcript from memory 56 in server 32. The user may see the transcript on display 40 and/or may print the transcript on printer 36. In the event server 32 includes voice identifier 64, the transcript may include identifications of the individual persons who participated in the conversation and what each person said.

In practice, modules such as voice recognizer 52, translation engine 54 and speech synthesizer 66 may be compartmentalized for each language. One voice recognizer may recognize English, for example, and another voice recognizer may recognize Mandarin Chinese. Similarly, one speech synthesizer may generate speech in Spanish, while a separate speech synthesizer may generate speech in Arabic. For simplicity of illustration, all voice recognizer modules, translator modules and speech synthesizer modules are combined in FIG. 2. The invention is not limited to any particular hardware or software to implement the modules.

Translations that are performed in the manner described above may be subject to translation errors from various sources. Homophones, words with multiple meanings and jargon, for example, may introduce errors into the translation. Translation engine 54 may therefore use tools such as terminology manager 58, translation memory tools 60 and/or machine translation tools 62 to obtain a more accurate translation.

One terminology manager tool is a dictionary sequence. The user may specify one or more lexicons that assist in the translation. The lexicons may be specific to a topic, for example, or specific to communicating with the other party. For example, the user may have a personal lexicon that holds words, phrases and clauses commonly employed by the user. A user may also have access lexicons appropriate to a specific industry or subject matter, such as business negotiations, proper names, military terms, technical terminology, medical vocabulary, legal terminology, sports-related expressions or informal conversation.

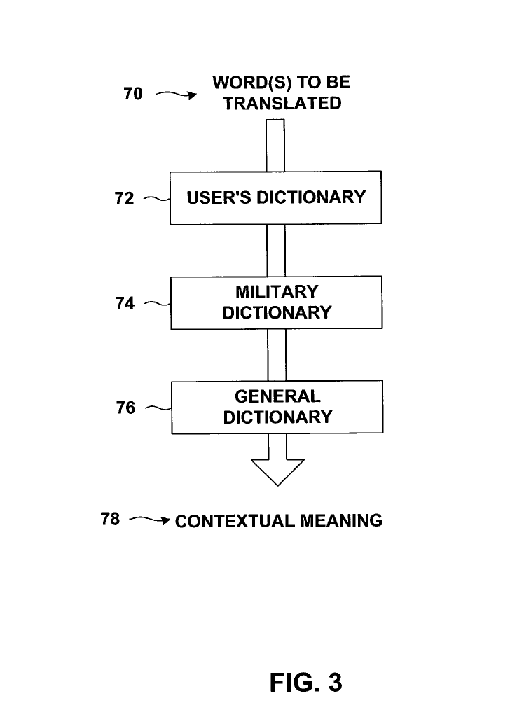

The user may also establish a sequence of priority of the dictionaries, as illustrated in FIG. 3. Translation engine 54 may look up the words, phrases or clauses to be translated (70) in one or more dictionaries according to a user-specified hierarchy. In FIG. 3, the first lexicon to be searched is the personal dictionary of the user (72). The personal dictionary may include words, phrases and clauses that the user employs frequently. The second lexicon to be searched may be a specialized context-oriented dictionary. In FIG. 3, it is assumed that the user expects to discuss military topics, and has therefore selected a military dictionary (74). The user has given the general dictionary (76) the lowest priority.

Any or all of the dictionaries may be searched to find the words, phrases or clauses that correspond to the contextual meaning (78) to be conveyed. The hierarchy of dictionaries may make the search for the intended meaning (78) quicker and more efficient. For example, suppose the user employs the English word “carrier.” In the user's personal dictionary (72), “carrier” may in most situations refer to a radio wave that can be modulated to carry a signal. The most likely contextual meaning (78) may therefore be found quickly. Searches of other dictionaries (74, 76) may generate other possible meanings of the term, such as a kind of warship or a delivery person. These meanings may not be what the user intended, however.

Suppose the user employs the phrase “five clicks.” This term might not be found in the personal dictionary (72), but may be found in the military dictionary (74). The term may be identified as a measurement of distance, as opposed to a number of sounds.

The user may specify a dictionary sequence prior to a conversation, and may change the sequence during the conversation. Translation engine 54 may use the dictionary sequence as a tool for understanding context and preparing translation.

Dictionary sequencing may be one of many terminology manager tools for handling subject matter-specific terminology. Other tools may be available as well. Another terminology manager tool may, for example, recognize concepts such as collections of words or phrases. In some circumstances, it is more accurate and efficient to map a concept to a second language than to perform a word-by-word translation. With a conceptual translation, the phrase “I changed my mind” may be properly translated as a “I modified my opinion,” rather than improperly translated word-by-word as “I replaced my brain.” Other terminology manager tool may be tailored to identify and translate words, phrases, clauses and concepts pertaining to particular subject matter, such as matters in legal, medical or military domains.

In some applications, the translation need not be provided in “real time.” Translation engine 54 may encounter ambiguities, and the ambiguities may affect the translation. Ambiguities may arise even though a dictionary sequence is employed. Accordingly, the translation may be temporarily stored in memory 56 and ambiguities and other aspects may be presented to the user for resolution. Server 32 may interrogate the user about the meaning the user wishes to convey.

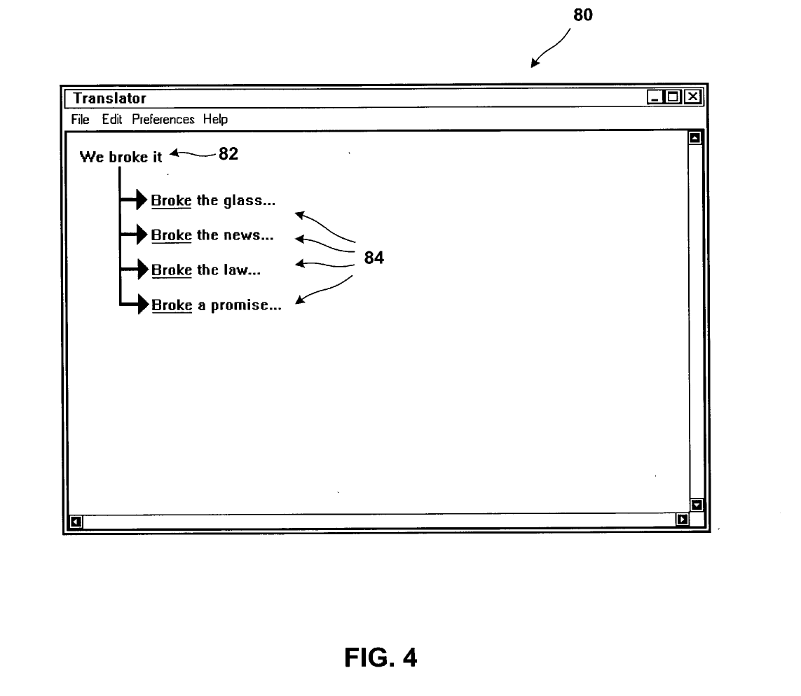

FIG. 4 shows an exemplary interrogation screen 80 that may be presented to a user. The user has used a phrase in the first language, namely, the English phrase “We broke it.” This phrase is recognized by voice recognizer 52 and is echoed 82 on screen 80. Translation engine 54 has encountered and identified an ambiguity in translating the word “broke.” The word “broke” may have several meanings, each of which may be translated as a different word in the second language. By context, translation engine 54 may be able to determine that “broke” represents a verb as opposed to an adjective.

Screen 80 presents the user with a menu of choices 84, from which the user can select the intended meaning. The user may make the selection with mouse 44, keyboard 42 or other input/output device. The order of the choices in the menu may be a function of the dictionary sequence, such that the most likely meanings may be presented first.

In FIG. 4, menu of choices 84 is context-based. In other words, the word “broke” is presented in four different phrases, with the word “broke” having a different meaning in each phrase. Menu 84 may be displayed in other formats as well, such as a series of synonyms. Instead of “Broke the glass,” for example, screen 80 may display text such as “Broke: shattered, fractured, collapsed.” In another alternative format, screen 80 may present the user with a speculation as to the most likely intended meaning, and may give the user the opportunity to confirm that the speculation is correct. The user may specify the format for the display of menu 84.

When the user selects the desired meaning, translation engine 54 performs the appropriate translation, based at least in part on the interrogation or the response of the user to the interrogation. In the event additional ambiguities or other aspects are presented, the user may be interrogated regarding the ambiguities or aspects. When the ambiguities or aspects are resolved, the translation may be supplied to speech synthesizer 66 for conversion to voice data.

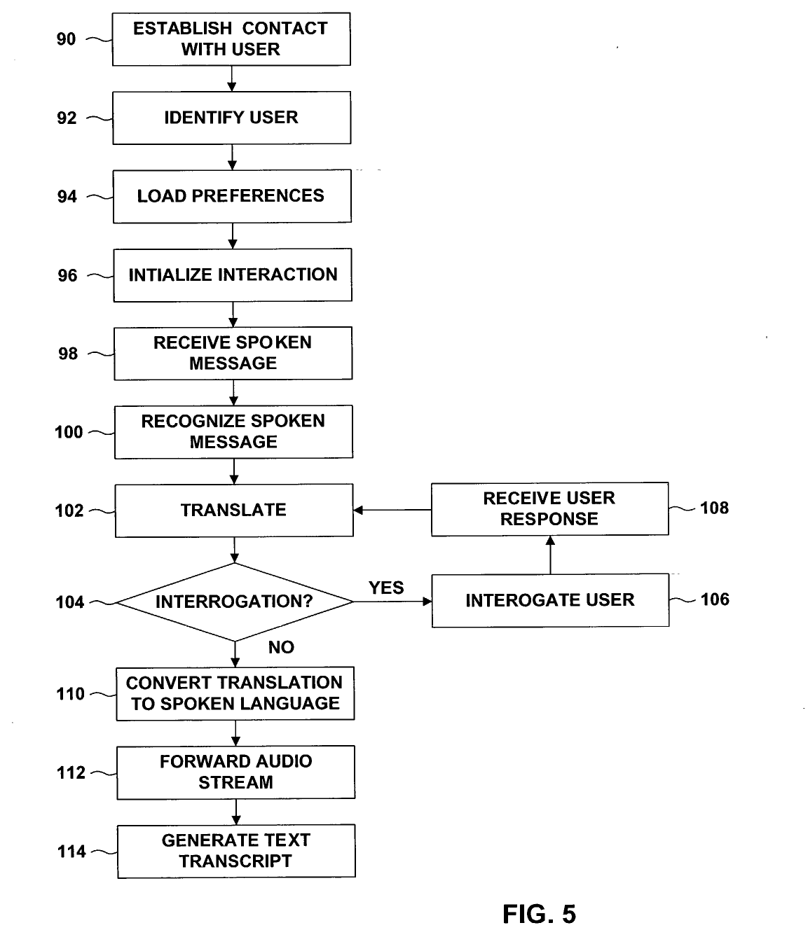

FIG. 5 is a flow diagram illustrating techniques employed by server 32. After establishing contact with the user (90), server 32 may be ready to receive data including audio input. Server 32 may identify the user (92) for purposes such as billing, authentication, and so forth. Circumstances may arise when the user will be away from his office or on a pay telephone. To obtain access to server 32, the user may enter one or more identifiers, such as an account number and/or a password. In one application of the invention, the user's voice may be recognized and identified by voice identifier 64.

Once the user is identified, controller 50 may load the preferences of the user (94) from memory 56. Preferences may include a dictionary sequence, translation engine files for default first and second languages, and the like. User preferences may also include a voice profile. A voice profile includes data pertaining to the voice of a particular user that may improve recognition rates of voice recognizer 52. User preferences may further include display preferences, which may provide the user information about the content of the translation buffer or a running transcript of the conversation. In addition, user preferences may include presentation of ambiguities in a context-based format, such as the format shown in FIG. 4, or another format. The user may change any of the preferences.

Server 32 may initialize the interaction between the parties to the conversation (96). Initialization may include establishing voice contact with the second party. In some embodiments of the invention, the user may direct server 32 to establish contact with the second party. The user may, for example, give a voice command to controller 50 to make a connection with a particular telephone number. The command may be recognized by voice recognizer 52 and may be carried out by controller 50.

In one embodiment of the invention, the commands to server 32 may be voice driven, allowing for hands-off operation. Voice-driven operation may be advantageous when, for example, a hand-operated input/output device such as a mouse or keyboard is unavailable. Voice commands may be used to control translation and edit messages. Voice commands may include predefined keywords that are recognized as commands, such as “Translate that,” “Select dictionary sequence,” “Undo that,” “Move back four words,” and so forth.

In addition, server 32 may be programmed to detect pauses, and may automatically translate the contents of the translation buffer upon detection of a pause, without an explicit command to “Translate that.” Translation engine 54 may use a pause as an indicator of a translatable subset message such as a phrase or clause. Pause-triggered translation may be useful in many circumstances, such as when the user is making an oral presentation to an audience. Pause-triggered translation may, for example, allow translation engine 54 to translate part of a sentence before the user is finished speaking the sentence. As a result, the translated message in the second language may quickly follow the oral presentation of the message in the first language.

Once the interaction between the parties begins, controller 50 may process messages spoken in the first language or messages spoken in the second language. In general, processing phrases includes receiving a spoken message (98), recognizing the spoken message (100), translating the message or subsets of the message (102), identifying and clarifying aspects such as ambiguities (104, 106, 108) and supplying the translation (110, 112). For purposes of illustration, the processing of a spoken message will first be illustrated in the context of translating a message spoken by the user in a first language into a message spoken in a second language.

Recognition of the message (100) and translation of the message (102) may be cooperative processes among many modules of server 32. In general, voice recognizer 52 typically filters the incoming audio signal and recognizes the words spoken by the user. Voice recognizer 52 may also cooperate with translation engine 54 to parse the message into subset messages such as words, and collections of words, such as phrases and clauses. In one embodiment of the invention, translation engine 54 may use context to determine the meaning of words, phrases or clauses, e.g., to distinguish similar-sounding words like “to,” “two” and “too.” Context-based translation also improves recognition (100), as similar sounding words like “book,” “brook,” “cook,” “hook” and “took” are more likely to be translated correctly.

Even with context-based translation, some recognition and translation errors or ambiguities may be present. Server 32 may determine whether an aspect of the translation presents a problem that may require resolution by the user (104) and may interrogate the user about the problem (106). Controller 50 may regulate interrogation.

FIG. 4 shows one example of an interrogation for resolving an ambiguity. Other forms of interrogation are possible. Controller 50 may, for instance, ask the user to repeat or rephrase an earlier statement, perhaps because the statement was not understood or perhaps because the user employed words that have no equivalent in the second language. Controller 50 may also ask the user whether a particular word is intended as a proper name.

Controller 50 may receive the response of the user (108) and translation engine 54 may use the response in making the translation (102). Controller 50 may also store the response in memory 56. If the same problem should arise again, translation memory tools 60 may identify the previously translated words, phrases or clauses, and may be able to resolve the problem by referring to memory 56 for context and previous translations. When translation engine 54 identifies an ambiguity, controller 50 may search memory 56 to determine whether the ambiguity has been previously resolved. Extracting the intended meaning from memory 56 may be faster and more preferable to initiating or repeating an interrogation to the user.

The extent of control of the user over the translation and the degree of interrogation may be user-controlled preferences. These preferences may be loaded automatically (94) at the outset of the session.

In one embodiment of the invention, the user is interrogated in connection with every spoken word, phrase, clause or sentence. The user may be presented with a written or audio version of his words and phrases, and asked to confirm that the written or audio version is correct. The user may be allowed to edit the written or audio version to clarify the intended meaning and to resolve ambiguities. The user may delay translation until the meaning is exactly as desired. In circumstances in which it is important that translations be accurate, careful review by the user of each spoken sentence may be advantageous. Translation of a single sentence may involve several interactions between the user and server 32.

In this embodiment, the user may choose to use one or more translation engines to translate the message from the first language to the second language, then back to the first language. This technique may help the user gain confidence that the meaning of the message is being translated correctly.

In another embodiment of the invention, the user may be more interested in conveying the “gist” of a message instead of a specific meaning. Accordingly, the user may be interrogated less frequently, relying more on terminology manager tools and translation memory tools to reduce translation errors. With less interrogation, the conversation may proceed at a more rapid pace.

In a further embodiment, interrogation may be eliminated. Server 32 may use terminology manager tools and translation memory tools to reduce translation errors. This mode of usage may allow a more rapid conversation, but may also be more prone to error.

When the translation is complete, speech synthesizer 66 may convert the translation into an audio stream (110). Speech synthesizer 66 may, for example, select from audio files containing phonemes, words or phrases, and may assemble the audio files to generate the audio stream. In another approach, speech synthesizer 66 may use a mathematical model of a human vocal tract to produce the correct sounds in an audio stream. Depending upon the language, one approach or the other may be preferred, of the approaches may be combined. Speech synthesizer 66 may add intonation or inflection as needed.

Server 32 may forward the audio stream to the second party (112). Server 32 may also generate and maintain a transcript of the user's words and phrases and the translation provided to the second party (114).

When server 32 receives words in the second language from the second party, server 32 may employ similar translation techniques. In particular, server 32 may receive spoken words and phrases (98), recognize the words and phrases (100) and prepare a translation (102). The translation may be converted to an audio stream (110) and forwarded to the user (112), and may be included in the transcript (114).

In some applications, the second party may be interrogated in a manner similar to the user. Interrogation of the second party is not necessary to the invention however. In many circumstances, the user may be the only party to the conversation with interactive access to server 32. When the second party's intended meaning is unclear, any of several procedures can be implemented.

For example, server 32 may present the user with alternate translations of the same words or phrases. In some cases, the user may be able to discern that one translation is probably correct and that other possible translations are probably wrong. In other cases, the user may ask the second party to rephrase what the second party just said. In still other cases, the user may ask the second party for a clarification of one particular word or phrase, rather than a restatement of everything just said.

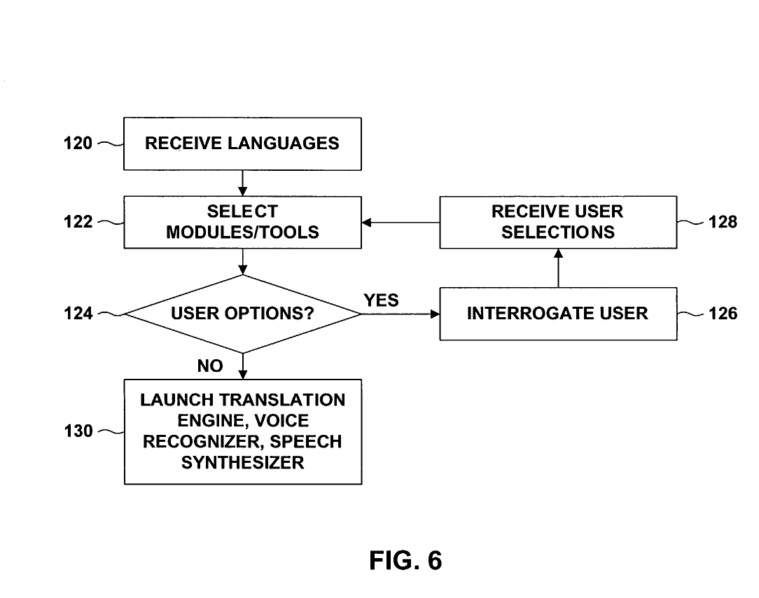

FIG. 6 illustrates selection of modules and/or tools by controller 50. Controller 50 may select, for example, one or more translation engines, translation tools, voice recognition modules or speech synthesizers. The selected modules and/or tools may be loaded, i.e., instructions, data and/or addresses for the modules and/or tools may be placed in random access memory.

The user may specify the modules and/or tools that may be used during a conversation. As noted above, controller 50 may load user preferences for modules and/or tools automatically (94) but the user may change any of the preferences. Upon command by the user, controller 50 may select or change any or all of the modules or tools used to translate a message from one language to another.

Selection modules and/or tools may depend upon various factors. In the exemplary situation FIG. 6, the selection depends upon the languages used in the conversation. Controller 50 receives the languages (120) specified by the user. The user may specify languages via an input/output device at local workstation 34, or by voice command. An exemplary voice command may be “Select language pair English Spanish,” which commands server 32 to prepare to translate English spoken by the user into Spanish, and Spanish into English.

Controller 50 may select modules and/or tools as a function of one or both selected languages (122). As noted above, modules such as voice recognizer 52, translation engine 54 and speech synthesizer 66 may be different for each language. Translation tools such as terminology manager 58, translation memory tools 60 and machine translation tools 62 also may depend upon the language or languages selected by the user.

For some particular languages or pairs of languages, controller 50 may have only one choice of modules or tools. There may be, for example, only one available translation engine for translating English into Swedish. For other particular languages or pairs of languages, however, controller 50 may have a choice of available modules and tools (124). When there is a selection of modules or tools controller 50 may interrogate the user (126) about what modules or tools to use.

In one implementation of interrogation (126), controller 50 may list available translation engines, for example, and ask the user to select one. Controller 50 may also interrogate the user in regards to particular versions of one or more languages. In the example in which the user has specified languages of English and Spanish, controller 50 may have one translation engine for Spanish spoken in Spain and a modified translation engine for Spanish spoken in Mexico. Controller 50 may interrogate the user (126) as to the form of Spanish that is expected in the conversation, or may list the translation engines with notations such as “Preferred for Spanish speakers from Spain.”

Controller 50 receives the selection of the version (128) and selects modules and/or tools accordingly (122). The selected modules and/or tools may then be launched (130), i.e., instructions, data and/or addresses for the selected modules and/or tools may be loaded into random access memory for faster operation.

The techniques depicted in FIG. 6 are not limited to selecting modules and/or tools as a function of the languages of the conversation. The user may give server 32 a command pertaining to a particular tool, such as a dictionary sequence, and controller 50 may select tools (122) to carry out the command. Controller 50 may also select a modified set of modules and/or tools in response to conditions such as a change in the identity of the user or a detected bug or other problem in a previously selected module or tool.

One advantage of the invention may be that several translation modules and/or tools may be made available to a user. The invention is not limited to any particular translation engine, voice recognition module, speech synthesizer or any other translation modules or tools. Controller 50 may select modules and/or tools adapted to a particular conversation, and in some cases the selection may be transparent to the user. In addition, the user may have a choice of translation engines or other modules or tools from different suppliers, and may customize the system to suit the user's needs or preferences.

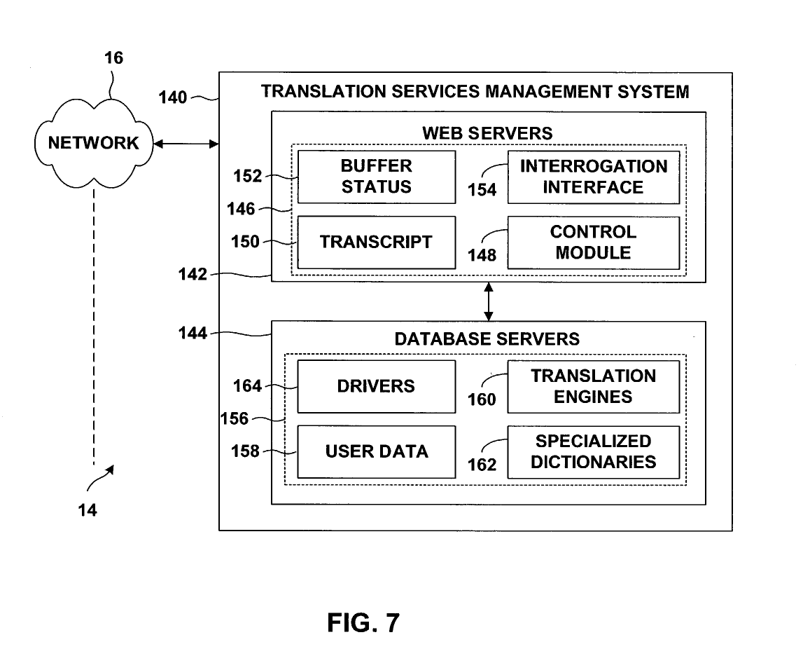

FIG. 7 is a block diagram illustrating an example embodiment of server side 14 of translation system 10. In this embodiment, a selection of modules or tools for a variety of languages may be available to several users. Server side 14 may be embodied as a translation services management system 140 that includes one or more web servers 142 and one or more database servers 144. The architecture depicted in FIG. 7 may be implemented in a web-based environment and may serve many users simultaneously.

Web servers 142 provide an interface by which one or more users may access translation functions of translation services management system 140 via network 16. In one configuration, web servers 142 execute web server software, such as Internet Information Server™ from Microsoft Corporation, of Redmond, Wash. As such, web servers 142 provide an environment for interacting with users according to software modules 146, which can include Active Server Pages, web pages written in hypertext markup language (HTML) or dynamic HTML, Active X modules, Lotus scripts, Java scripts, Java Applets, Distributed Component Object Modules (DCOM) and the like.

Although software modules 146 are illustrated as operating on server side 14 and executing within an operating environment provided by web servers 142, software modules 146 could readily be implemented as client-side software modules executing on local workstations used by users. Software modules 146 could, for example, be implemented as Active X modules executed by a web browser executing on the local workstations.

Software modules 146 may include a number of modules including a control module 148, a transcript module 150, a buffer status module 152 and an interrogation interface module 154. Software modules 146 are generally configured to serve information to or obtain information from a user or a system administrator. The information may be formatted depending upon the information. Transcript module 150, for example, may present information about the transcript in the form of text, while buffer status module 152 may present translation buffer-related information graphically. An interrogation interface module 154 may present an interrogation in a format similar to that shown in FIG. 4, or in another format.

Control module 148 may perform administrative functions. For instance, control module 148 may present an interface by which authorized users may configure translation services management system 140. A system administrator may, for example, manage accounts for users including setting access privileges, and define a number of corporate and user preferences. In addition, a system administrator can interact with control module 148 to define logical categories and hierarchies for characterizing and describing the available translation services. Control module 148 may further be responsible for carrying out the functions of controller 50, such as selecting and loading modules, tools and other data stored on database servers 144. Control module 148 may also launch the modules or tools, and may supervise translation operations.

Other modules may present information to the user pertaining to a translation of a conversation. Transcript module 150 may present a stored transcript of the conversation. Buffer status module 152 may present information to the user about the content of the translation buffer. Interrogation interface 154 may present interrogation screens to the user, such as interrogation screen 80 shown in FIG. 4, and may include an interface to receive the response of the user to the interrogation. Transcript module 150, buffer status module 152 and interrogation interface 154 may present information to the user in platform-independent formats, i.e., formats that may be used by a variety of local workstations.

Many of the modules and tools pertaining to a language or a set of languages may be stored on a set of database servers 144. The database management system of database servers 144 may be a relational (RDBMS), hierarchical (HDBMS), multidimensional (MDBMS), object-oriented (ODBMS or OODBMS) or object-relational (ORDBMS) database management system. The data may be stored, for example, within a single relational database such as SQL Server from Microsoft Corporation.

At the outset of a session, database servers 144 may retrieve user data 158. User data may include data pertaining to a particular user, such as account number, password, privileges, preferences, usage history, billing data, personal dictionaries and voice pattern. Database servers 144 may also retrieve one or more files 160 that enable translation engines as a function of the languages selected by the user. Translation engine files 160 may include data such as vocabulary and grammar rules, as well as procedures and tools for performing translation. Translation engine files 160 may include complete translation engines, or files that customize translation engines for the languages selected by the user. When the user specifies a dictionary sequence, one or more specialized dictionaries 162 may also be retrieved by database servers 144. Drivers 164 that drive modules such as voice recognizer 52, voice identifier 64 and speech synthesizer 66, may also be retrieved by database servers 144.

Database servers 144 may hold translation engine files 160, specialized dictionaries 162 and drivers 164 for a variety of languages. Some language translations may be supported by more than one translator, and different translators may offer different features or advantages to the user. By making these translation resources available in this fashion, translation services management system 140 may operate as a universal translator, allowing a user to translate words spoken virtually any first language into words spoken in virtually any second language, and vice versa.

As noted above, the invention is not limited to messages that are received in spoken form. The invention may also receive messages in written form, such as messages saved as text files on a computer. The invention may employ many of the techniques described above to translate the written messages. In particular, written messages may bypass voice recognition techniques and may be loaded directly into the translation buffer in memory 56. Following translation of the written message, the translated message may be presented in written form, audible form, or both.

In one application of the invention, the user presents a speech to an audience. The user employs demonstrative aids in the speech, such as slides of text stored electronically on local workstation 34. The text may be stored, for example, as one or more documents prepared with word-processing, slide presentation or spreadsheet applications such as Microsoft Word, Microsoft PowerPoint or Microsoft Excel. Translation system 10 may translate the words spoken by the user, and may further translate the text in the demonstrative aids. When the user responds to an interrogation, translation engine 54 performs the appropriate translation of the written message, the spoken message, or both, based at least in part on the interrogation or the response of the user to the interrogation.

The user may control how the translated messages are presented. For example, a translation of the speech may be presented in audible form, and a translation of the demonstrative aids may be presented in written form. Alternatively, the user may allow members of the audience to determine whether to receive the translated messages in written form, audible form, or a combination of both.

The invention can provide one or more additional advantages. A single server may include resources for translating several languages, and several users may simultaneously have access to these resources. As the resources become enhanced or improved, all users may benefit from the most current versions of the resources.

In some embodiments, the server may provide translation resources to a variety of user platforms, such as personal computers, PDA's and cellular telephones. In addition, a user may customize the system to the user's particular needs by setting up one or more personal dictionaries, for example, or by controlling the degree of interrogation.

With user interrogation, translations can more accurately reflect the intended meaning. The degree of interrogation may be under the control of the user. In some applications, more than one party to a conversation may use interrogation to craft a message in an unfamiliar language.

Several embodiments of the invention have been described. Various modifications may be made without departing from the scope of the invention. For example, server 32 may provide additional functionality such as receipt, translation and transmission of a message in a written form, without need for voice recognizer 52 and/or speech synthesizer 66. These and other embodiments are within the scope of the following claims.

1. A method comprising:
receiving a message in a first language from a user;
interrogating the user about an aspect of the message;
translating the message to a second language based at least in part on the interrogation.

2. The method of claim 1, further comprising:
identifying an ambiguity in the message; and
interrogating the user about the ambiguity.

3. The method of claim 1, wherein receiving the first message comprises receiving an audio message.

4. The method of claim 3, further comprising recognizing words in the audio message.

5. The method of claim 1, further comprising receiving a response from the user to the interrogation.

6. The method of claim 5, further comprising translating the message to a second language as a function of the response.

7. The method of claim 6, wherein translating the message to the second language comprises generating an audio stream.

8. The method of claim 5, further comprising storing the response in memory.

9. The method of claim 5, further comprising:
receiving a second message in the first language from the user;
translating the second message to a second language based at least in part on the response.

10. The method of claim 1, wherein the message is a first message, and wherein the first message is one of an audio message and a written message, the method further comprising:
receiving a second message in the first language from a user, wherein the second message is the other of an audio message and a written message; and
translating the second message to the second language.

11. The method of claim 10, further comprising translating the second message to the second language based at least in part on the interrogation.

12. A system comprising:
a translation engine that translates a message in a first language to a second language; and
a controller that interrogates a user when the translation engine identifies an ambiguity when translating the message in the first language to a second language.

13. The system of claim 12, wherein the message is a spoken message, the system further comprising a voice recognizer that recognizes the message spoken in the first language.

14. The system of claim 13, further comprising a voice identifier that identifies the voice speaking the spoken message.

15. The system of claim 13, wherein the voice recognizer parses the message spoken in the first language into subsets comprising at least one of words, phrases and clauses.

16. The system of claim 15, wherein the voice recognizer transmits the subsets of the message to the translation engine.

17. The system of claim 15, further comprising memory that stores the subsets of the message as a transcript.

18. The system of claim 12, further comprising a speech synthesizer that converts the message in the second language to an audio stream.

19. The system of claim 12, further comprising memory that stores a transcript of the message.

20. The system of claim 12, wherein the controller interrogates the user about an aspect of the message and wherein the translation engine translates the message to the second language based at least in part on the interrogation.

21. The system of claim 20, wherein the controller identifies an ambiguity in the message and interrogates the user about the ambiguity.

22. A method comprising:
receiving a first audio message in a first language;
translating the first message to a second language;
generating a first audio stream as a function of the first message in the second language;
receiving a second audio message in the second language;
translating the second message to the first language;
generating a second audio stream as a function of the second message in the first language; and
storing a transcript comprising the first message and the second message in at least one of the first language and the second language.

23. The method of claim 22, further comprising:
generating an interrogation;
receiving a response to the interrogation; and
translating the first message to the second language as a function of the response.

24. The method of claim 23, further comprising:
identifying an ambiguity in the first message; and
generating an interrogation as a function of the ambiguity.

25. A method comprising:
receiving a first language specified by a user;
receiving a second language specified by the user; and
selecting a translation engine file as a function of at least one of the first language and the second language.

26. The method of claim 25, further comprising:
interrogating the user;
receiving a response to the interrogation; and
selecting a translation engine file as a function of the response.

27. The method of claim 25, further comprising launching the translation engine file.

28. The method of claim 25, further comprising:
selecting a driver for voice recognizer as a function of at least one of the first language and the second language; and
launching the driver.

29. The method of claim 25, further comprising:
selecting a driver for a speech synthesizer as a function of at least one of the first language and the second language; and
launching the driver.

30. A system comprising:
a database storing a plurality of translation engine files; and
a controller that selects a translation engine file from the plurality of translation engine files.

31. The system of claim 30, wherein the controller receives a first language specified by a user and a second language specified by the user, and selects the translation engine file as a function of the first and second languages.

32. The system of claim 30, wherein the database further stores a plurality of special dictionaries, and wherein the controller selects at least one special dictionary from the plurality of special dictionaries.

33. The system of claim 30, further comprising an interrogation interface that transmits interrogations to a user.

34. A method comprising:
translating a first portion of a first message in a first language to a second language;
identifying an ambiguity in the first message;
interrogating a user about the ambiguity;
receiving a response to the interrogation;
translating a second portion of the first message to the second language as a function of the response; and
translating a second message in the first language to a second language as a function of the response.

35. The method of claim 34, further comprising storing the identification of the ambiguity and the response in memory.

36. The method of claim 35, further comprising:
identifying a second ambiguity in the second message;
searching the memory for previous identifications of the second ambiguity.

37. A method comprising:
receiving a dictionary sequence from a user comprising a first dictionary and a second dictionary;
receiving a message in a first language;
parsing the message into subsets in the first language comprising at least one of words, phrases and clauses;
searching the first dictionary for subsets in a second language that correspond to the subsets in the first language; and
thereafter searching the second dictionary for subsets in the second language that correspond to the subsets in the first language.

38. The method of claim 37, wherein the dictionary sequence further comprises a third dictionary, the method further comprising thereafter searching the third dictionary for subsets in the second language that correspond to the subsets in the first language.

39. The method of claim 37, further comprising:
finding a first subset in the second language in one of the first dictionary and the second dictionary;
finding a second subset in the second language in one of the first dictionary and the second dictionary;
interrogating the user about which of the first subset and the second subset should be used;
receiving a response to the interrogation; and
translating the message to the second language as a function of the response.

40. A method comprising:
receiving an audio message in a first language;
recognizing the audio message;
storing the recognized audio message in memory;
detecting a pause in the audio message; and
upon detecting the pause, translating the recognized audio message in memory to a second language.

41. The method of claim 40, further comprising:
generating an interrogation;
receiving a response to the interrogation; and
translating the first message to the second language as a function of the response.
